(19) United States
(12) Patent Application Publication
(10) Pub. No.: US 2026/0143441 A1
(43) Pub. Date: May 21, 2026

(54) SYNCHRONIZATION SIGNAL (SS) BLOCK STRUCTURES

(71) Applicant: Lenovo (United States) Inc., Morrisville, NC (US)

(72) Inventors: Karthikeyan GANESAN, Nauheim (DE); Ali Ramadan ALl, Kraiburg am Inn (DE); Ravi KUCHIBHOTLA, Chicago, IL (US)

(21) Appl. No.: 18/949,646

(22) Filed: Nov. 15, 2024

(51) Int. Cl. H04W 56/00; H04B 7/06; H04L 5/00; H04W 74/0833

(52) U.S. Cl. CPC H04W 56/0015; H04B 7/06968; H04W 74/0833; H04L 5/0007

(57) ABSTRACT

Various aspects of the present disclosure relate to an enhanced synchronization signal (SS) block structure or design for 6G radio access technologies and other access technologies. The SS block structures may enable the transmission of physical broadcast channel (PBCH) signals at periodicities different than, unique to, or separate from periodicities of SS bursts, such as SS bursts that comprise multiple synchronization signal (SS) blocks. For example, the synchronization signal block structures may decouple the PBCH (and/or other channels) from the SS, facilitating time division multiplexing and/or frequency division multiplexing of the PBCH with respect to the synchronization signals of the SS block.

### TECHNICAL FIELD

The present disclosure relates to wireless communications, and more specifically to synchronization signal (SS) block structures.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support XL MIMO technologies, such as large-scale deployments (1000+) of antenna elements, which can improve the capacity of the network, data rates, and spectral efficiency. For example, 6G radio access technologies may include an antenna element configuration of 5000 or more antenna elements in an upper mid-band frequency (e.g., 7 to 24 GHz).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to provide enhanced SS block structures (e.g., SS block structures adapted for 6G radio access technologies), such as SS block structures configured to transmit physical broadcast channel (PBCH) signals at periodicities different than periodicities of SS block bursts.

A network entity for wireless communication is described. The network entity may be configured to, capable of, or operable to perform one or more operations as described herein. For example, the network entity may comprise at least one memory and at least one processor coupled with the at least one memory and configured to cause the network entity to configure an SS block to include a primary synchronization signal (PSS) at a first symbol and a secondary synchronization signal (SSS) at a second symbol adjacent to the first symbol and transmit an SS block burst comprising multiple configured SS blocks, wherein each SS block is transmitted using a different transmission beam of multiple transmission beams.

A method performed or performable by network entity is described. The method may comprise configuring an SS block to include a PSS at a first symbol and an SSS at a second symbol adjacent to the first symbol and transmitting an SS block burst comprising multiple configured SS blocks, wherein each SS block is transmitted using a different transmission beam of multiple transmission beams.

In some implementations of the network entity and method described herein, the network entity and method may further be configured to, capable of, performed, performable, or operable to transmit a PBCH burst with a time domain offset from the transmission of the SS block burst.

In some implementations of the network entity and method described herein, the PBCH burst contains multiple PBCH block transmissions using different transmission beams of the multiple transmission beams based on the configuration, and wherein the PBCH burst is based on a quasi-colocation (QCL) assumption with respect to a doppler spread, a doppler shift, an average gain, an average delay, a delay spread, or a spatial receiving parameter, between the SS block burst and the PBCH burst.

In some implementations of the network entity and method described herein, a periodicity of the PBCH burst is different or an integer multiple of a periodicity of the SS block burst.

In some implementations of the network entity and method described herein, the PBCH burst is part of a minimum system information (MSI) burst, and wherein the network entity and method may be configured to transmit a common channel burst, within an active time of the network entity, which comprises the SS block burst, the MSI burst, a paging burst, and a random access channel (RACH) burst.

In some implementations of the network entity and method described herein, the network entity and method may further be configured to, capable of, performed, performable, or operable to map, via time division multiplexing (TDM) a control resource set (CORESET) to the SS block burst and map, via the TDM, an enhanced PBCH (ePBCH) to the PBCH burst.

In some implementations of the network entity and method described herein, the network entity and method may further be configured to, capable of, performed, performable, or operable to transmit an MSI burst that comprises the CORESET and the ePBCH.

In some implementations of the network entity and method described herein, each SS block of the SS block burst contains the PSS in an orthogonal frequency division multiplexing (OFDM) symbol and the SSS in a consecutive OFDM symbol.

In some implementations of the network entity and method described herein, the network entity and method may further be configured to, capable of, performed, performable, or operable to configure the SS block burst to include 7 PSS/SSS occasions in a slot without a gap that contains 14 OFDM symbols.

A network entity for wireless communication is described. The network entity may be configured to, capable of, or operable to perform one or more operations as described herein. For example, the network entity may comprise at least one memory and at least one processor coupled with the at least one memory and configured to cause the network entity to configure an SS block burst to include a first PSS at a first OFDM symbol, a second PSS at a second OFDM symbol adjacent to the first OFDM symbol, and a first SSS at an OFDM symbol positioned after the second OFDM symbol, and transmit the SS block burst based on the configuration.

A method performed or performable by network entity is described. The method may comprise configuring an SS block burst to include a first PSS at a first OFDM symbol, a second PSS at a second OFDM symbol adjacent to the first OFDM symbol, and a first SSS at an OFDM symbol positioned after the second OFDM symbol and transmitting the SS block burst based on the configuration.

In some implementations of the network entity and method described herein, the network entity and method may further be configured to, capable of, performed, performable, or operable to cause the network entity to configure the SS block burst to include a first PBCH signal at an OFDM symbol that is between the second OFDM symbol and the OFDM symbol mapped to the first SSS and a second PBCH signal at an OFDM symbol that is positioned after the OFDM symbol mapped to the first SSS.

In some implementations of the network entity and method described herein, the network entity and method may further be configured to, capable of, performed, performable, or operable to cause the network entity to configure the SS block burst to include a second SSS at an OFDM symbol positioned adjacent to the OFDM symbol mapped to the first SSS.

In some implementations of the network entity and method described herein, the OFDM symbol mapped to first SSS is adjacent to the second OFDM symbol, and wherein at least one processor and method are further configured to cause the network entity to configure the SS block burst to include a second SSS at an OFDM symbol adjacent to the OFDM symbol mapped to first SSS.

In some implementations of the network entity and method described herein, the network entity and method may further be configured to, capable of, performed, performable, or operable to cause the network entity to transmit the SS block burst via beam sweeping within a geographical location associated with the network entity.

### BRIEF DESCRIPTION OF THE DRAWINGS

FIG. 1 illustrates an example of a wireless communications system in accordance with aspects of the present disclosure.

FIG. 2A illustrates an example of an SS block in accordance with aspects of the present disclosure.

FIG. 2B illustrates an example of an SS burst in accordance with aspects of the present disclosure.

FIGS. 3A-3C illustrate examples of SS bursts and MSI bursts in accordance with aspects of the present disclosure.

FIG. 4A illustrates an example of SS burst sets grouped with MSI burst sets in accordance with aspects of the present disclosure.

FIG. 4B illustrates an example of an SS burst and corresponding PBCH burst in accordance with aspects of the present disclosure.

FIGS. 5A-5B illustrate examples of common channel bursts in accordance with aspects of the present disclosure.

FIGS. 6A-6B illustrate examples of periodicities of common channel bursts in accordance with aspects of the present disclosure.

FIGS. 7A-7B illustrate examples of SSB block structures in accordance with aspects of the present disclosure.

FIG. 8 illustrates an example of an SS block in accordance with aspects of the present disclosure.

FIGS. 9A-9D illustrate examples of frequency division multiplexing of SSB structures in accordance with aspects of the present disclosure.

FIG. 10 illustrates an example time division multiplexing mapping of an SS block to other channels in accordance with aspects of the present disclosure.

FIG. 11 illustrates an example frequency division multiplexing mapping of an SS block to other channels in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a network equipment (NE) in accordance with aspects of the present disclosure.

FIG. 15 illustrates a flowchart of a method performed by an NE in accordance with aspects of the present disclosure.

FIG. 16 illustrates a flowchart of a method performed by an NE in accordance with aspects of the present disclosure.

FIG. 17 illustrates a flowchart of a method performed by an NE in accordance with aspects of the present disclosure.

FIG. 18 illustrates a flowchart of a method performed by an NE in accordance with aspects of the present disclosure.

### DETAILED DESCRIPTION

During cell search operations, a UE receives and utilizes synchronization signals from a cell (e.g., a base station or other network entity) to determine information that enables the UE to access the cell. For example, the cell may transmit SSBs every 5 milliseconds or with other periodicities (e.g., 5 ms, 10 ms, 20 ms, and so on). To provide for coverage over an entire cell area, the cell may perform beam sweeping. Beam sweeping entails communication of one or more cell defining SSB bursts (or burst sets), where each SSB burst includes a set of SSBs, and where each SSB may be transmitted by a different or separate beam.

For 5G (new radio, or NR) wireless access technologies, the SSB burst size is 5 ms (e.g., half of a radio frame), where the SSBs are transmitted in a first half or a second half of a radio frame. Based on the frequency range and subcarrier spacings of the cell, the maximum candidate SSBs is 64, which can be accommodated by 5 ms SSB burst sizes.

However, radio access technologies that deploy an XL MIMO configuration (e.g., a 6G network having a configuration of 1024 antenna elements and 256 transceiver units, or TxRUs) cannot utilize 5 ms SSB burst sizes. Such configurations support a large number of SSBs in the upper mid band frequencies, which increases latency and prevents use of the shorter SSB burst sizes.

The systems and methods described herein introduce an enhanced SS block structure or design for XL MIMO configurations and other 6G radio access technologies. The SS block structures may enable the transmission of PBCH signals at periodicities different than, unique to, or separate from periodicities of SS bursts, such as SS bursts that comprise multiple synchronization signal (SS) blocks (e.g., PSS/SSS blocks). Thus, an SS block may be a group or pair of two adjacent OFDM symbols that each contain a PSS and/or an SSS.

For example, the SS block structures may decouple the PBCH (and/or other channels) from the SS, facilitating time division multiplexing and/or frequency division multiplexing of the PBCH with respect to the synchronization signals of the SS block. Further, the SS block structures may repeat SS blocks, such that an SS block burst includes multiple PSSs and/or SSSs.

Thus, the SS block structure facilitates a cell to transmit the PBCH and the SS with a same beam, providing flexibility to schedule and/or transmit the PBCH and the SS using different periodicities. This flexibility may reduce overhead associated with initial access signal acquisition for a UE or UEs and may reduce cell detection latency for the UE or UEs, among other benefits.

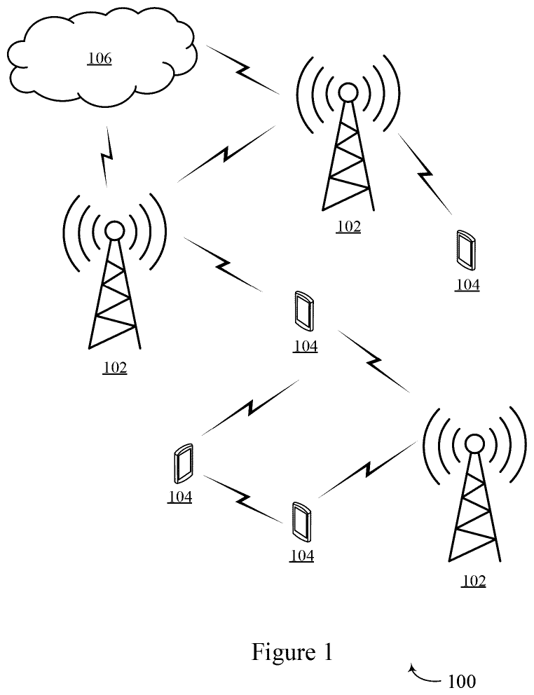

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, ρ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a new or enhanced SSB design or structure enables the transmission of PBCH signals at periodicities different than periodicities of SS bursts, such as SS bursts that comprise multiple SS blocks (e.g., PSS/SSS blocks). In some cases, the SSB structures described herein may be implemented by a cell (e.g., a base station, such as a gNB, eNodeB or other NE 102) having an XL MIMO configuration or other configuration suitable to be deployed as a 6G radio access technology. The cell may have a large antenna array size (e.g., 1024 antenna elements). The large antenna array size may also introduce farfield, nearfield, and/or frequency dependent/beam squinting effects, along with carrier bandwidths in the 7 to 24 GHz spectrum and/or a mmWave spectrum (e.g., above 28 GHz).

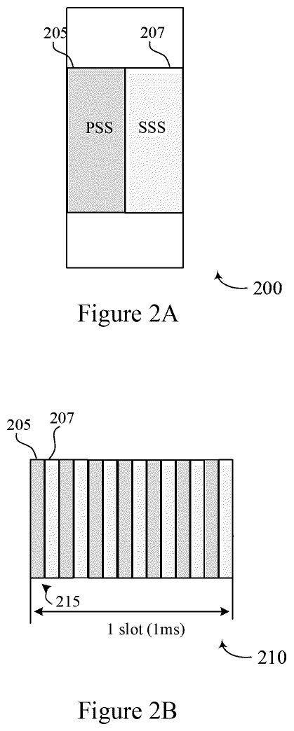

FIG. 2A illustrates an example of an SS block 200 in accordance with aspects of the present disclosure. The SS block contains a PSS 205 and an SSS 207 occupying adjacent OFDM symbols. Table 1 presents resource information for the SS block, such as information indicating the positioning of the synchronization signals (e.g., PSS and SSS 207) within the SS block 200.

TABLE 1

| Channel | OFDM symbol number l | Subcarrier number k |
|---|---|---|
| or | relative to the | relative to the |
| Signal | start of an SS block | start of an SS block |
| PSS | 0 | 56, 57, . . . , 182 |
| SSS | 1 | 56, 57, . . . , 182 |
| Set to 0 | 0, 1 | 0, 1, . . . , 55, 183, 184, . . . , 239 |

As described herein, an SS burst may include multiple transmission occasions of PSS/SSS (e.g., pairs of PSS/SSS). FIG. 2B illustrates an example of an SS burst 210 in accordance with aspects of the present disclosure. The SS burst 210 includes up to seven transmission occasions 215 of the PSS 205 and the SSS 207 within one slot (1 ms) of the SS burst 210.

For example, a slot having 14 OFDM contiguous symbols (e.g., no gaps) can may up to seven transmission occasions 215, where each of the transmission occasions 215 corresponds to a synchronization transmission beam in a same or different spatial direction. Thus, for 128 SS blocks, an OFDM starting symbol of a candidate SS Block may be {0, 2, 4, 6, 8, 10, 12}+14n, where n=0, 1, 2 . . . 126.

In some cases, the slot may exclude the PSS 205 or the SSS 207 from a first OFDM symbol, such as an OFDM symbol #0 (e.g., due to the presence of a PDCCH or CORESET). Thus, for 128 SS blocks, an OFDM starting symbol of a candidate SS Block may be {1, 3, 5, 7, 9, 11}+14n, where n=0, 1, 2 . . . 126.

In some cases, the slot may contain a guard symbol in a last OFDM symbol (e.g., symbol #13). In some cases, the slot may not position the PSS 205 or the SSS 207 in a middle symbol ((e.g., symbol #7). Thus, based on some or all of the configurations of the slot, the slot may facilitate the transmission of five or six transmission occasions 215.

Further, in some cases, where a gap symbol is used for beam switching or where there are M gap symbols for every N contiguous SS blocks transmission in a slot, a slot may include 4 to 6 PSS/SSS occasions/SS blocks. For example, with 128 SS blocks, an OFDM starting symbol of a candidate SS Block may be {0, 2, 4, 6, 8, 10, 12}+14n, where n=0, 1, 2 . . . 126. As another example, an OFDM starting symbol of a candidate SS Block may be {2, 4, 7, 9, 11}+14n, where n=0, 1, 2 . . . 126. As another example, an OFDM starting symbol of a candidate SS Block may be {1, 3, 5, 8, 10, 12}+14n, where n=0, 1, 2 . . . 126.

Using the SS burst 210, the cell may perform beam sweeping using multiple transmission occasions 215 per beam. Thus, unlike other SSB structures (e.g., 5G SSB structures), the SS block 200 facilitates separation of a PBCH signal from the SS, enabling the cell to transmit the PBCH with a periodicity that is different than a periodicity of the SSs (the PSS 205 and/or the SSS 207).

In some embodiments, the cell may transmit a PBCH signal after an SSB burst, facilitating and/or providing a different periodicity of the PBCH signal transmission within a PBCH burst compared to the SSB burst transmission periodicity. For example, the PBCH may be transmitted in a time domain offset from the synchronization signal and after the synchronization burst or a time domain offset from the synchronization signal (e.g., within the SS burst period or duration). In some cases, the PBCH periodicity is an integer multiple of the SSB periodicity.

Further, a quasi-colocation (QCL) assumption may occur when a base station transmits the synchronization block and the PBCH using the same beam. The QCL assumption may include a Doppler spread, a Doppler shift, an average gain, an average delay, a delay spread, spatial reception (Rx) parameters, and so on,

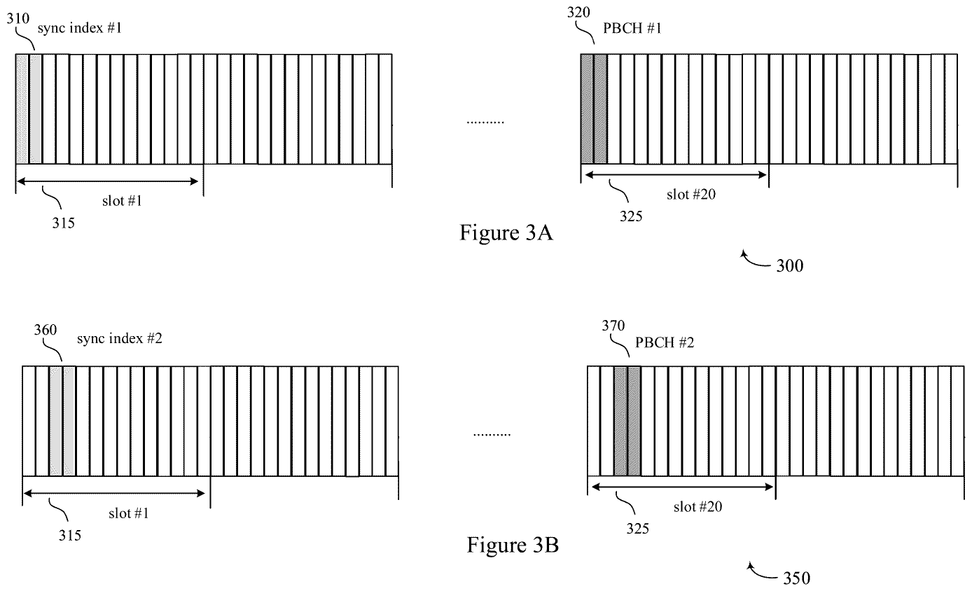

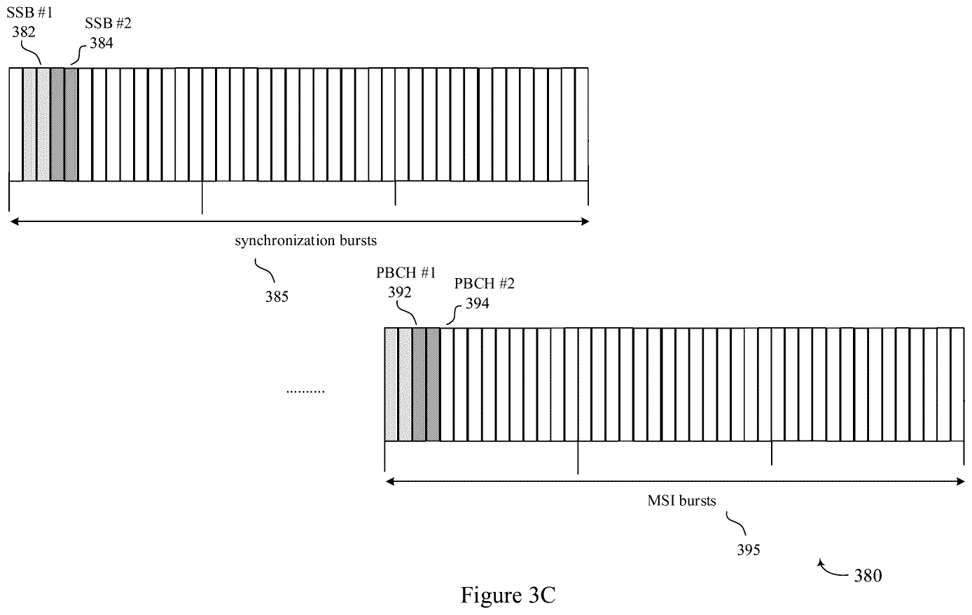

FIGS. 3A-3C illustrate examples of SS bursts and MSI bursts in accordance with aspects of the present disclosure.

FIG. 3A depicts a radio frame 300 comprising an SSB 310 (e.g., sync index #1) within a first slot 315 (e.g., slot #1) offset from a PBCH signal 320 (e.g., PBCH #1) within a later slot 325 (e.g., slot #20, which occurs 20 ms after slot #1). FIG. 3B depicts a radio frame 350 comprising an SSB 360 (e.g., sync index #2) within the first slot 315 (e.g., slot #1) offset from a PBCH signal 370 (e.g., PBCH #2) within the later slot 325 (e.g., slot #20, which occurs 20 ms after slot #1).

Thus, the radio frames 300, 350 comprise PBCH signals within PBCH bursts transmitted with a fixed offset from their corresponding synchronization signals, within synchronization bursts. In some cases, the fixed offset, represented by OFDM symbols, milliseconds, and/or slots, may be configurable based on a table or predefined in the specification. As described herein, the PBCH burst may contain multiple PBCH blocks transmitted by the cell via different beams and/or a single beam may comprise the PBCH transmission and corresponding SS block.

FIG. 3C depicts a radio frame 380 comprising a synchronization burst 385 (e.g., containing an SSB #1 382 and an SSB #2 384) and an MSI burst 395 (e.g., containing a PBCH #1 392 and a PBCH #2 394). The radio frame 380 is configured to transmit the PBCH blocks 392, 394 in the PBCH burst 395, which corresponds to the SS blocks 382, 384 of the synchronization burst 385.

In some cases, a master information block (MIB) contained in the MSI burst 395 may include the number of the radio frame 380 (e.g., the radio frame number, or SFN). For example, the MIB may include the SFN for the radio frame 380 and/or information identifying an offset radio frame for the SS blocks when the SS blocks and associated PBCH blocks are not scheduled for the same radio frame.

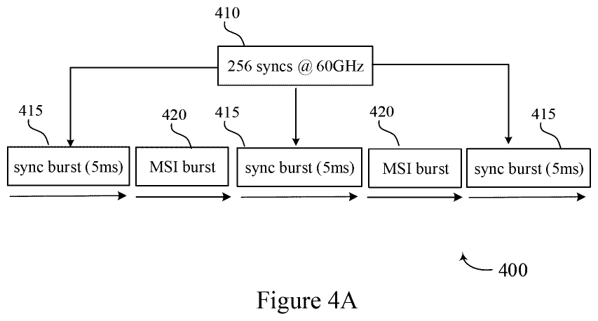

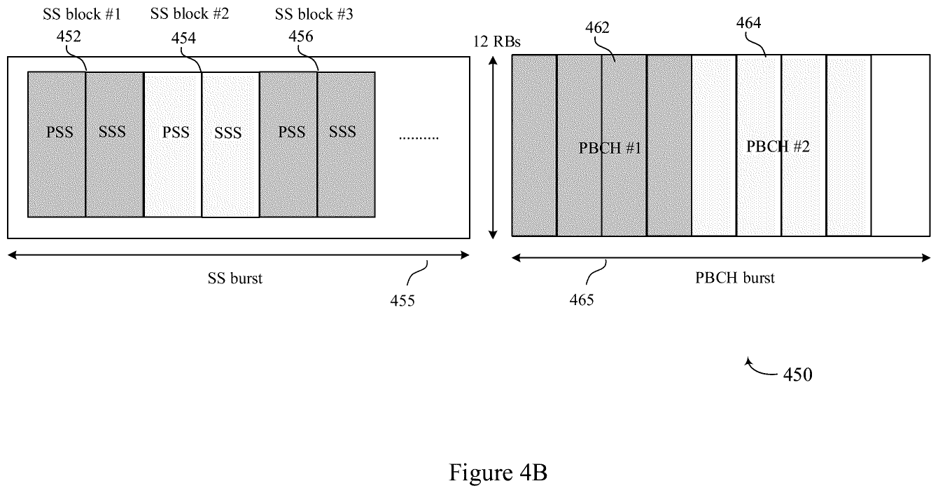

As described herein, in some embodiments, the cell may group SS bursts or SS burst sets with MSI bursts or MSI burst sets. FIG. 4A illustrates an example of SS burst sets grouped 400 with MSI burst sets in accordance with aspects of the present disclosure. A set of SSBs 410 (e.g., 256 SSBs at 60 GHz) are grouped into sync bursts 415 followed by MSI bursts 420. The cell may transmit the sync bursts 415 in a non-contiguous manner in 5 ms transmissions, injecting the MSI bursts 420, the CORESET #0, between every sync burst 415. In some cases, the CORESET #0 may contain a common search space configuration containing PDCCH scheduling the SIB0/SIB1.

In some embodiments, a PBCH may occupy a same number of frequency resources as an SS block. FIG. 4B illustrates an example 450 of an SS burst 455 and corresponding PBCH burst 465 in accordance with aspects of the present disclosure. The SS burst 455 includes multiple SS blocks 452, 454, 456, and the PBCH burst 465 included multiple PBCHs (e.g., PBCH 462 and PBCH 464). The PBCH (e.g., PBCH #1) may occupy 12 resource blocks (RBs) of a frequency resource, which is the same bandwidth for the SS blocks (e.g., SS block #1) with a guard subcarrier (e.g., 144 SCs). As another example, the PBCH may occupy 132 SCs (e.g., 11 RBs), which may be the same bandwidth for the SS blocks (e.g., SS block #1) when rounded to the nearest resource block in the frequency domain resources.

In some embodiments, the cell may transmit a new system information block or SIB (e.g., a new SIB0) using a new extended physical layer broadcast channel or using a physical downlink shared channel (PDSCH) scheduled by a common downlink control information (DCI), such as type-0 physical downlink control channel (PDCCH) transmitted within CORESET #0. In some cases, the SIB, or ePBCH, may have a periodicity that is an integer multiple (e.g., 2×, 3×, and so on) of the periodicity of the SS and/or the PBCH.

For example, an ePBCH block containing ePBCH symbols may be mapped in adjacent symbols to a PBCH block containing the PBCH symbol and the MSI burst (e.g., depicted in FIG. 3C), where the MSI burst contains both the PBCH symbol and the ePBCH and SIB1. As another example, the ePBCH block containing ePBCH symbols may be mapped with an offset from the PBCH symbol in a separate ePBCH burst, where the ePBCH burst is configured with a periodicity different than a periodicity of the other MSI burst.

As another example, the PBCH burst and ePBCH burst can be separately defined and configured from the MSI burst, where SIB1 can be configured to be transmitted within the MSI burst. In another example, the PBCH, ePBCH, and SIB1 can be configured to be transmitted within the MSI burst. Further, the network configuration may allow adaptation in the periodicities of the PBCH, the ePBCH the and SIB1 within the MSI burst.

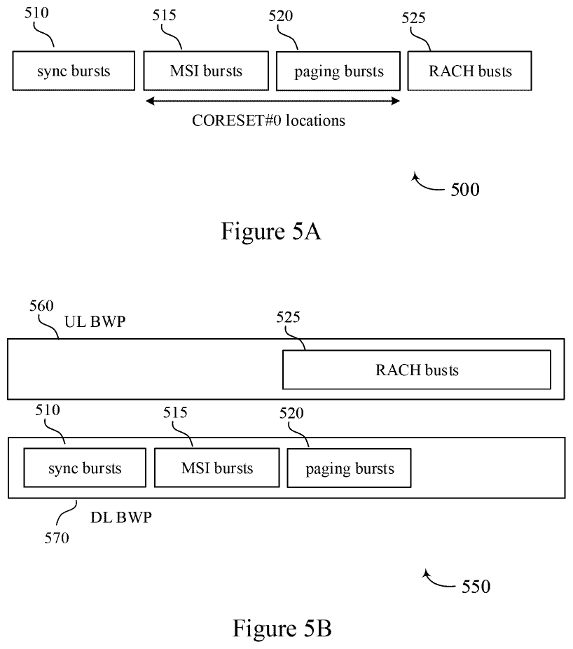

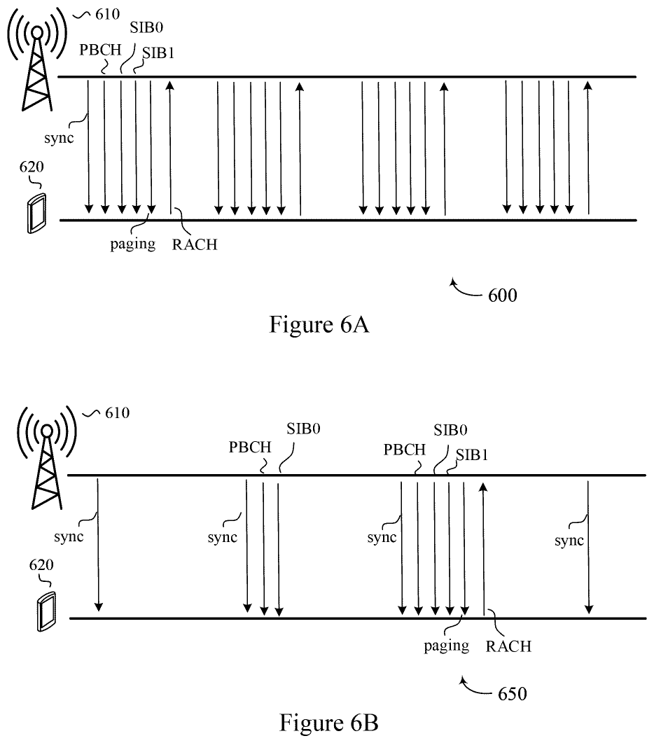

In some embodiments, to enable contiguous synchronization burst transmission, the CORESET #0 may be allocated within an MSI burst and/or a paging burst (e.g., and not be allocated within the synchronization bursts). For example, PDCCH transmitted within the CORESET #0 may be used to schedule SIB0, SIB1, paging, and so on. FIGS. 5A-5B illustrate examples of common channel bursts in accordance with aspects of the present disclosure.

FIG. 5A depicts common channel bursts within a common channel 500. The common channel 500 comprises synchronization bursts 510, MSI bursts 515, paging bursts (e.g., containing paging information) 520, and RACH bursts 525. The CORESET #0 may include scheduling information for a SIB0, a SIB1, and/or paging, and thus may be located and/or allocated with the MSI bursts 515 and/or. the paging bursts 520. In some cases, a CORESET #0 table index may be signaled using PBCH, along with PDCCH type 0 monitoring for the SIB0 (e.g., within the PBCH payload). In some cases, the CORESET #0 periodicity is an integer multiple of the SS periodicity and may have the same periodicity as the periodicity of the paging bursts 520 or ePBCH bursts.

Further, in some cases, CORESET #0 monitoring occasions may be configured within the MSI bursts 515 and/or the paging bursts 520 with a time domain offset from the corresponding SS block. The gap slots for the CORESET #0 may indicate a non-availability, which may be signaled such that it is not allocated within the SS burst (e.g., the sync bursts 510).

In some embodiments, a RACH resource may be allocated within the RACH bursts 525 for uplink transmission, where the RACH bursts 525 are mapped based on TDM and/or subband full duplex (SBFD). A RACH occasion (RO) within the RACH bursts 525 may contain multiple FDM resources within a time slot. FIG. 5B depicts an example mapping 550 of the RACH bursts 525.

For example, when a cell supports SBFD, the cell may configure an uplink bandwidth partition (UL BWP) 560 within a downlink time slot, and the RACH resource (e.g., an RO within the RACH bursts 525) can be configured within the UL BWP 560. Thus, the cell may reduce the latency of an UL RACH transmission by providing RACH resources without waiting for uplink slots for transmission.

In some cases, the UL BWP 560 may be configured as non-overlapped or partially overlapped a corresponding downlink BWP (DL BWP) 750. Thus, during partial overlap of the BWPs, the RACH resource may be allocated in a non-overlapped resource within the UL BWP 560. Further, a RACH burst periodicity may be configured separately or differently, because a UE may transmit an uplink RACH after receiving successful paging traffic or network originated traffic and/or may UE transmit the uplink RACH for device originated traffic.

In some embodiments, the common channel bursts include multiple channel bursts, which may start with an SS burst or synchronization burst. The channel bursts include synchronization bursts, PBCH, ePBCH, SIB1, paging bursts, and RACH bursts within a cell active time of a cell. The cell may configure each channel burst to have a separate, different, or unique periodicity (e.g., with respect to the other channel bursts within the cell active time). FIGS. 6A-6B illustrate examples of periodicities of common channel bursts in accordance with aspects of the present disclosure.

FIG. 6A depicts common channel burst periodicities 600 between a cell 610 and a UE 620, where each channel burst (e.g., sync burst, PBCH burst, SIB0 burst, SIB1 burst, paging burst, and RACH burst, depicted by the different arrows), is transmitted between the cell 610 and the UE 620 at different relative periodicities. For example, the sync burst (or SS burst) acts as reference burst for the other channel bursts, which may be transmitted as an integer multiple of the reference burst periodicity.

FIG. 6B depicts common channel burst periodicities 650 between the cell 610 and the UE 620, where each channel burst (e.g., sync burst, PBCH burst, SIB0 burst, SIB1 burst, paging burst, and RACH burst, depicted by the different arrows), is transmitted between the cell 610 and the UE 620 at different periodicities. For example, each channel burst may be separately configured with a certain reference burst (e.g., having a periodicity that is an integer multiple of the reference burst duration).

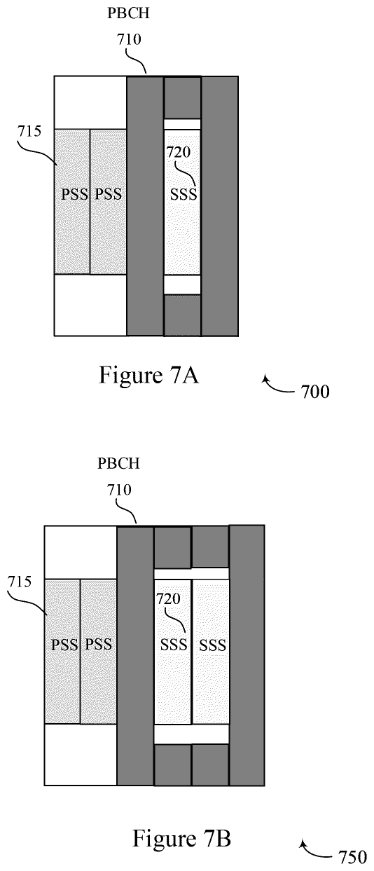

As described herein, in some embodiments, the structure of an SSB may have a number of configurations, such as configurations that include adjacent synchronization signals (e.g., PSS adjacent to SSS), repeating synchronization signals (e.g., a PSS followed by a PSS), and so on. FIGS. 7A-7B illustrate examples of SSB structures in accordance with aspects of the present disclosure.

FIG. 7A depicts an SSB structure 700 having five OFDM symbols. For example, in the time domain, the SSB structure 700 (e.g., an SS/PBCH block) includes five OFDM symbols (e.g., numbered in increasing order from 0 to 4), where PSS 715, SSS 720, and PBCH 710, with associated demodulation reference signal (DM-RS) are mapped to the five OFDM symbols of the SS/PBCH block.

Table 2 presents an example mapping to the five OFDM symbols:

TABLE 2

| Channel | OFDM symbol number l | Subcarrier number k |
|---|---|---|
| or | relative to the start | relative to the start |
| signal | of an SS/PBCH block | of an SS/PBCH block |
| PSS | 0 | 56, 57, . . . , 182 |
| PSS | 1 | 56, 57, . . . , 182 |
| SSS | 3 | 56, 57, . . . , 182 |
| Set to 0 | 0, 1 | 0, 1, . . . , 55, 183, 184, . . . , 239 |
| | 3 | 48, 49, . . . , 55, |
| | | 183, 184, . . . , 191 |
| PBCH | 2, 4 | 0, 1, . . . , 239 |
| | 3 | 0, 1, . . . , 47, |
| | | 192, 193, . . . , 239 |
| DM-RS | 2, 4 | 0 + v, 4 + v, 8 + v, . . . , 236 + v |
| for PBCH | 3 | 0 + v, 4 + v, 8 + v, . . . , 44 + v |
| | | 192 + v, 196 + v, . . . , 236 + v |

In the frequency domain, the SS/PBCH block may include 240 contiguous subcarriers, or SCs (e.g., numbered in increasing order from 0 to 239), where the quantities k and l represent the frequency and time indices, respectively, within one SS/PBCH block. A UE (e.g., the UE 104) may determine that complex-valued symbols corresponding to resource elements denoted as “Set to 0” in Table 2 are set to zero, and the quantity v in Table 2 is given by

$$v = {N}_{ID}^{cell} mod 4.$$

As shown in FIG. 7A, the OFDM symbols containing the PSS 715 are repeated (e.g., in the first and the second OFDM symbols) which can facilitate time and frequency synchronization, automatic gain control (AGC) adjustment, as well as identify the SSB to the UE 104. Further, repeating the PSS 715 may enable the UE 104 to perform AGC and time synchronization within the same SS/PBCH block without acquiring multiple SS/PBCH blocks, which can reduce the latency of the initial access.

Also, the cell may increase a SSB burst periodicity, which may lead to network energy saving because the UE 104 may achieve time/frequency synchronization and cell identification using fewer SSB bursts. However, the configuration of the cell may balance the size of the SS/PBCH block (e.g., the number of symbols increasing from 4 to 5) with the transmission of few SSB bursts to avoid or mitigate an increased overhead and latency of the SSB bursts due to the size of the SS/PBCH blocks.

FIG. 7B depicts an SSB structure 750 having six OFDM symbols. For example, in the time domain, the SSB structure 750 (e.g., an SS/PBCH block) includes six OFDM symbols (e.g., numbered in increasing order from 0 to 5), where PSS 715, SSS 720, and PBCH 710, with associated demodulation reference signal (DM-RS) are mapped to the six OFDM symbols of the SS/PBCH block.

Table 3 presents an example mapping to the six OFDM symbols:

TABLE 3

| Channel | OFDM symbol number l | Subcarrier number k |
|---|---|---|
| or | relative to the start | relative to the start |
| signal | of an SS/PBCH block | of an SS/PBCH block |
| PSS | 0 | 56, 57, . . . , 182 |
| PSS | 1 | 56, 57, . . . , 182 |
| SSS | 3 | 56, 57, . . . , 182 |
| SSS | 4 | 56, 57, . . . , 182 |
| Set to 0 | 0, 1 | 0, 1, . . . , 55, 183, 184, . . . , 239 |
| | 3, 4 | 48, 49, . . . , 55, |
| | | 183, 184, . . . , 191 |
| PBCH | 2, 5 | 0, 1, . . . , 239 |
| | 3, 4 | 0, 1, . . . , 47, |
| | | 192, 193, . . . , 239 |
| DM-RS | 2, 5 | 0 + v, 4 + v, 8 + v, . . . , 236 + v |
| for PBCH | 3, 4 | 0 + v, 4 + v, 8 + v, . . . , 44 + v |
| | | 192 + v, 196 + v, . . . , 236 + v |

In the frequency domain, the SS/PBCH block may include 240 contiguous subcarriers, or SCs (e.g., numbered in increasing order from 0 to 239) as described with respect to Table 2, where the quantities k and l represent the frequency and time indices, respectively, within one SS/PBCH block.

As shown in FIG. 7B, the OFDM symbols containing the PSS 715 are repeated (e.g., in the first and the second OFDM symbols) and the OFDM symbols containing the SSS 720 are repeated (e.g., in the fourth and the fifth OFDM symbols).

Using the SSB structure 750, the cell can facilitate time and frequency synchronization within a same SS/PBCH block, reducing the latency of the initial access. In some cases, the cell may increase the SSB burst periodicity, resulting in network energy saving (e.g., a UE may achieve time/frequency synchronization and perform cell identification with fewer SS/PBCH bursts. However, as described herein, the implementation of the SSB structure may be based on a balance between overhead/latency increases due to the increased number of symbols (e.g., the number of symbols increasing from 4 to 6) with the transmission of fewer SSB bursts.

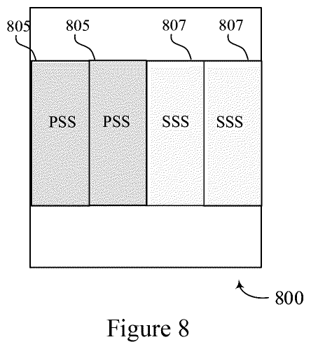

In some embodiments, an SSB structure may include the repetition of the PSS and the SSS. FIG. 8 illustrates an example of an SS block 800 in accordance with aspects of the present disclosure. The SS block 800, in the time domain, may include four OFDM symbols (e.g., numbered in increasing order from 0 to 3), where a PSS 805 and an SSS 807 are mapped to four consecutive OFDM symbols.

Table 4 presents an example mapping to the four OFDM symbols:

TABLE 4

| | OFDM symbol number l | Subcarrier number k |
|---|---|---|
| Channel | relative to the start | relative to the start |
| or signal | of an SS block | of an SS block |
| PSS | 0 | 56, 57, . . . , 182 |
| PSS | 1 | 56, 57, . . . , 182 |
| SSS | 2 | 56, 57, . . . , 182 |
| SSS | 3 | 56, 57, . . . , 182 |
| Set to 0 | 0, 1, 2, 3 | 0, 1, . . . , 55, 183, 184, . . . , 239 |

In the frequency domain, the SS/PBCH block may include 240 contiguous subcarriers, or SCs (e.g., numbered in increasing order from 0 to 239) as described with respect to Table 2, where the quantities k and l represent the frequency and time indices, respectively, within one SS/PBCH block.

As shown in FIG. 8, the OFDM symbols containing the PSS 805 are repeated (e.g., in the first and the second OFDM symbols) and the OFDM symbols containing the SSS 807 are repeated (e.g., in the third and the fourth OFDM symbols). Such repetition of the PSS 805 and the SSS 807 may facilitate time and frequency synchronization, ACG adjustment, identify the SSB, and so on.

In some cases, the cell may increase the SSB burst periodicity, resulting in network energy saving (e.g., a UE may achieve time/frequency synchronization and perform cell identification with fewer SS/PBCH bursts. However, as described herein, the implementation of the SSB structure with PSS/SSS repetition may be based on a balance between overhead/latency increases with the transmission of fewer SSB bursts.

In some embodiments, an SS block, in the time domain, comprises two OFDM symbols (e.g., numbered from 0 to 2), where the PSS and the SSS are mapped to the OFDM symbols, and in the frequency domain, the SS block may include 240 contiguous subcarriers, or SCs (e.g., numbered in increasing order from 0 to 239), as described herein.

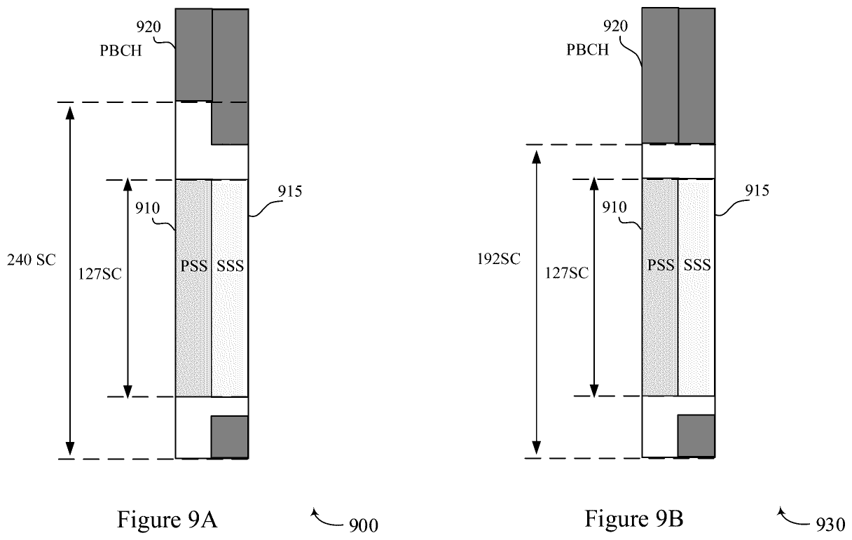

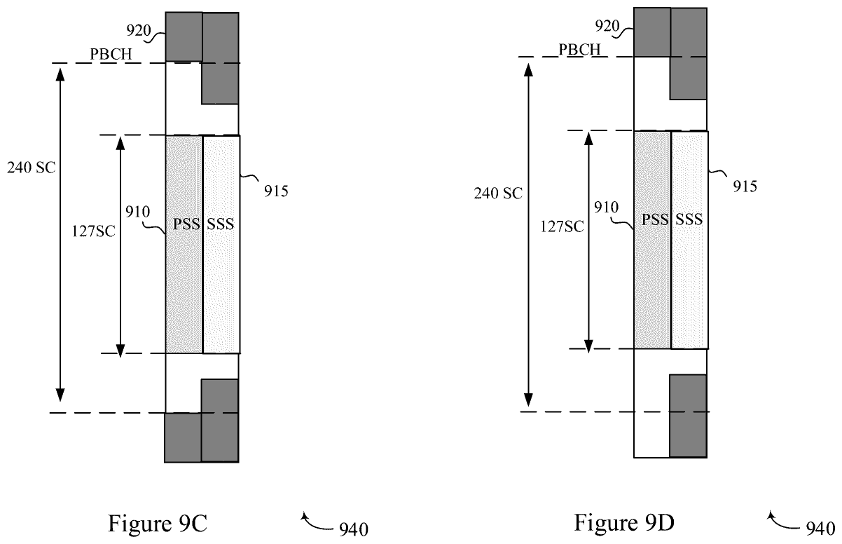

The SS block may comprise an SSB structure where the PSS and the SSS are mapped to the first two OFDM symbols and the PBCH is mapped, via frequency division multiplexing or around the frequency resources, with respect to the SS block (e.g., the PSS and the SSS). In some cases, a portion of the PBCH may be transmitted below and/or above the SS block (e.g., the PSS and the SSS). FIGS. 9A-9D illustrate examples of frequency division multiplexing of SSB structures in accordance with aspects of the present disclosure.

FIG. 9A depicts a first SS block structure 900, where a PSS 910 occupies a first OFDM symbol and spans over 127 subcarriers, while guard subcarriers are above and below the PSS 910, giving a total PSS 910, including guard subcarriers, as occupying 240 subcarriers. An SSS 915 is located in a second OFDM symbol and spans over 127 subcarriers. There are 8 unused subcarriers below the SSS 915 and 9 unused subcarriers above the SSS 915. The PBCH occupies 240 subcarriers in the first and second OFDM symbols, and spans 48 subcarriers below and above the SSS 915 in the second OFDM symbol. This results in PBCH occupying 576 subcarriers across two OFDM symbols (240+48+48+240=576).

FIG. 9B depicts a second SS block structure 930, where the PSS 910 occupies a first OFDM symbol and spans over 127 subcarriers, while guard subcarriers are above and below the PSS 910, giving a total PSS 910, including guard subcarriers, as occupying 192 subcarriers. The SSS 915 is located in the second OFDM symbol and spans over 127 subcarriers. There are 8 unused subcarriers below the SSS 915 and 9 unused subcarriers above the SSS 915, and the PSS 910 and the SSS 915 occupy 192 subcarriers. The PBCH occupies 264 subcarriers in the first and second OFDM symbols, and spans 48 subcarriers below the SSS 915 in the second OFDM symbol. This results in PBCH occupying 576 subcarriers across two OFDM symbols (240+48+48+240=576).

FIG. 9C depicts a third SS block structure 940, where the PSS 910 occupies a first OFDM symbol and spans over 127 subcarriers, while guard subcarriers are above and below the PSS 910, giving a total PSS 910, including guard subcarriers, as occupying 192 subcarriers. The SSS 915 is located in the second OFDM symbol and spans over 127 subcarriers. There are 8 unused subcarriers below the SSS 915 and 9 unused subcarriers above the SSS 915. The PBCH occupies 240 subcarriers in the first and second OFDM symbols (e.g., 120 SCs above and below), and spans 48 subcarriers below and above the SSS 915 in the second OFDM symbol. This results in PBCH occupying 576 subcarriers across two OFDM symbols (240+48+48+240=576). In some cases, because the PBCH 920 is mapped below the PSS 910 and the SSS 915, the mapping of the SS block, from a carrier reference point A, may have a minimum offset of resource blocks.

FIG. 9D depicts a fourth SS block structure 950, where the PSS 910 occupies a first OFDM symbol and spans over 127 subcarriers, while guard subcarriers are above and below the PSS 910, giving a total PSS 910, including guard subcarriers, as occupying 192 subcarriers. The SSS 915 is located in the second OFDM symbol and spans over 127 subcarriers. There are 8 unused subcarriers below the SSS 915 and 9 unused subcarriers above the SSS 915. The PBCH occupies 240 subcarriers in the first and second OFDM symbols (e.g., 120 SCs above and below the SSS 915), and spans 48 subcarriers below and above the SSS 915 in the second OFDM symbol. This results in PBCH occupying 576 subcarriers across two OFDM symbols (240+48+48+240=576). In some cases, because the PBCH 920 is mapped below the PSS 910 and the SSS 915, the mapping of the SS block, from a carrier reference point A, may have a minimum offset of resource blocks.

In some embodiments, the PBCH 920 may be mapped in a third OFDM symbol immediately after the SSS, with the third OFDM symbol allocated for the PBCH 920, the number of PBCH SCs mapped in the first and second SC being reduced in the frequency domain and mapped to the third OFDM symbol. Thus, the mapping of the PBCH 920 in the three OFDM symbols can be 120 SCs above the PSS 910 in the first OFDM symbol, 120+48 SCs in the second OFDM symbol above the SSS 915 and 48 SCs below the SSS 915 and 240 SCs in the third OFDM symbol, where 120+120+48+48+240=576 SCs for the PBCH 920 in three OFDM symbols. Further, the block structures described herein may be part of various combinations for the PBCH 920. In some cases, the third OFDM symbol for the PBCH 920 after the SSS 915 may be added in combination with the block structures and may reduce the overall frequency bandwidth used to map the PBCH 920 above and below the PSS 910 and the SSS 915.

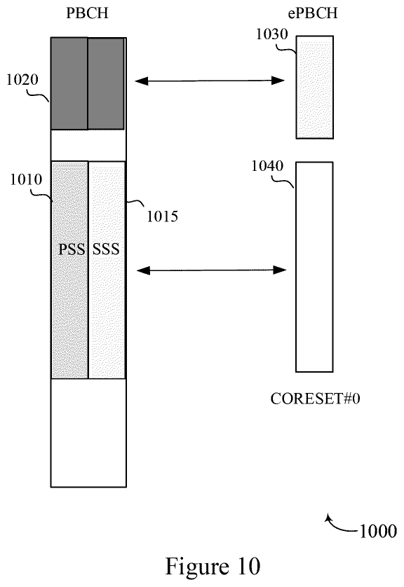

As described herein, in some embodiments, a CORESET #0 may be mapped, via TDM, with an SS block, and an ePBCH may be mapped, via TDM, with a PBCH block. FIG. 10 illustrates an example time division multiplexing mapping 1000 of an SS block to other channels in accordance with aspects of the present disclosure. As depicted in FIG. 10, a PSS 1010 and an SSS 1015 (e.g., an SS block) is mapped to a CORESET #0 1040, and a PBCH 1020 is mapped to an ePBCH 1030. In some cases, the PBCH 1020 may signal a location of the CORESET #0 1040 and type-0PDCCH monitoring and/or a time domain offset of the ePBCH 1030. Further, as depicted in FIG. 5A, an MSI burst (e.g., the MSI bursts 515) may transmit the CORESET #0 1040 and/or the ePBCH 1030.

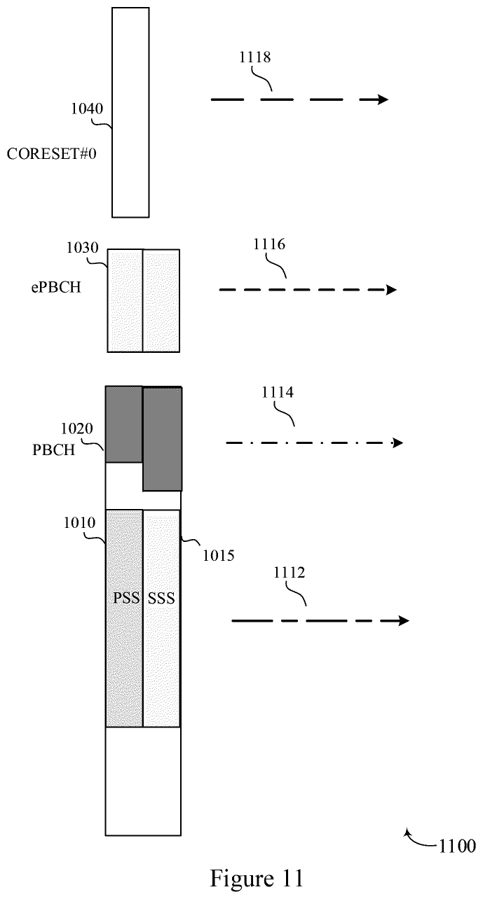

As described herein, in some embodiments, the CORESET #0 may be mapped, via FDM, with an SS block, and an ePBCH may be mapped, via FDM, with a PBCH block. FIG. 11 illustrates an example frequency division multiplexing mapping 1100 of an SS block to other channels in accordance with aspects of the present disclosure. In some cases, the PBCH 1020 may signal a location of the CORESET #0 1040 and type-0PDCCH monitoring and/or a frequency domain offset of the ePBCH 1030.

As depicted in FIG. 11, the SS block (e.g., the PSS 1010 and the SSS 1015) may have a first periodicity 1112, the PBCH 1020 may have a second periodicity 1114, the ePBCH 1030 may have a third periodicity 1116 and the CORESET #0 1040 may have a fourth periodicity 1118. In some cases, each of the periodicities 1114-1118 may be an integer multiple of the first periodicity 1112 of the SS block.

In some embodiments, a base station (e.g., the NE 102) may configure the TDM of the SS, the PBCH, and other channels and/or the FDM of the SS and the PBCH, and transmit the configuration to various UEs 104, such as internet of things (IoT) devices, low power devices, bandwidth limited devices, enhanced mobile broadband (eMBB) devices, and so on. The PBCHs may be predefined and transmitted with separate or unique periodicities. Further, contents of an MIB may have common parameters (e.g., radio frame numbers) and/or variable device-specific parameters for devices configured by the base station.

While the number of SCs and/or number of PRBs are shown as examples based on a 5G radio access technology, the 6G radio access technology may have or support different payloads, which may affect the number of SCs and/or PRBs. Thus, there may be differences for the number of SCs and number of PRBs (e.g., as mapped herein) when implemented using 6G payloads.

Further, in some embodiments, when an on-demand SS burst is triggered as part of a secondary cell activation command, the PBCH may not be transmitted together with the SS burst, and a network node (e.g., the base station) may only transmit the SS blocks within the SS burst for measurement purposes.

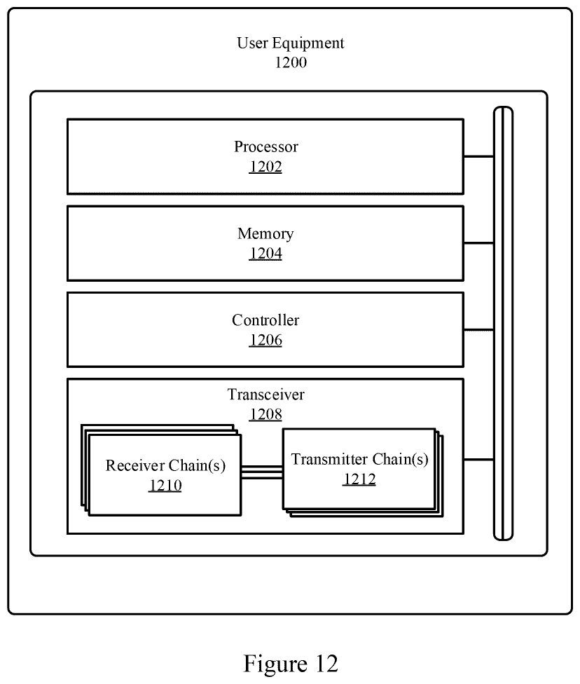

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 600 to perform various functions of the present disclosure.

The memory 1204 may include volatile or non-volatile memory. The memory 1204 may store computer-readable, computer-executable code including instructions when executed by the processor 1202 cause the UE 600 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 600 to perform one or more of the functions described herein (e.g., executing, by the processor 1202, instructions stored in the memory 1204). For example, the processor 1202 may support wireless communication at the UE 1200 in accordance with examples as disclosed herein.

The controller 1206 may manage input and output signals for the UE 600. The controller 1206 may also manage peripherals not integrated into the UE 600. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 600 may include at least one transceiver 1208. In some other implementations, the UE 600 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receive the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

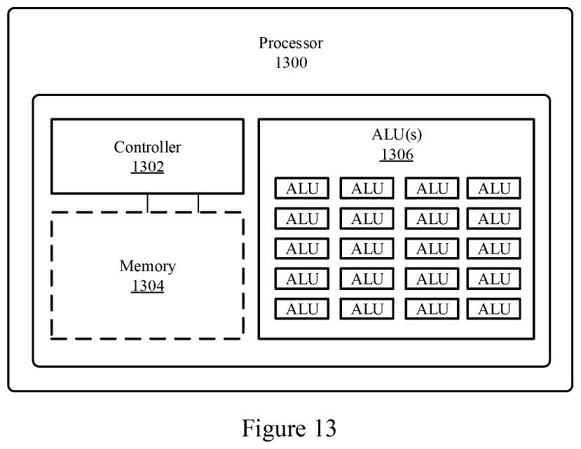

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein.

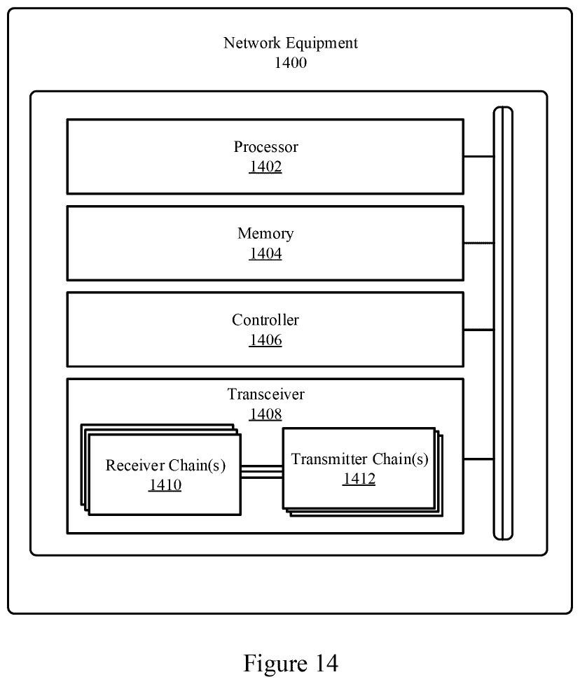

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404).

For example, the processor 1402 may support wireless communication at the NE 1400 in accordance with examples as disclosed herein. The NE 1400 may be configured to support a means for configuring an SS block to include a PSS at a first symbol and an SSS at a second symbol adjacent to the first symbol, and transmitting an SS block burst comprising multiple configured SS blocks, wherein each SS block is transmitted using a different transmission beam of multiple transmission beams.

As another example, the NE 1400 may be configured to support a means for configuring an SS block burst to include a first PSS at a first OFDM symbol, a second PSS at a second OFDM symbol adjacent to the first OFDM symbol, and a first SSS at an OFDM symbol positioned after the second OFDM symbol and transmitting the SS block burst based on the configuration.

As another example, the NE 1400 may be configured to support a means for configuring an SS block to include an SS having a PSS mapped to a first OFDM symbol and a SSS mapped to a second OFDM symbol adjacent to the first OFDM symbol, mapping, via FDM, a PBCH around the SS block, and transmitting the SS block.

As another example, the NE 1400 may be configured to support a means for configuring an SS block to include an SS having a PSS mapped to a first OFDM symbol and an SSS mapped to a second OFDM symbol adjacent to the first OFDM symbol, mapping, via FDM, a physical layer broadcast channel PBCH and a CORESET around the SS block and transmitting the SS block.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receive the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

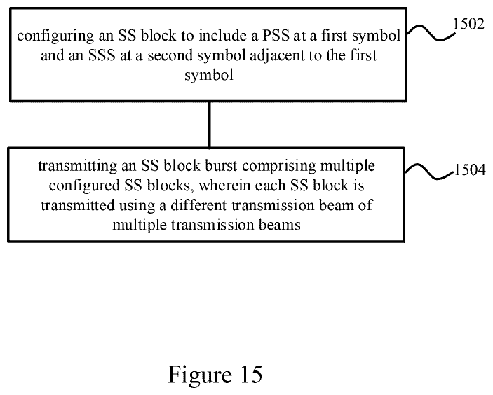

FIG. 15 illustrates a flowchart of a method in accordance with aspects of the present disclosure. The operations of the method may be implemented by an NE as described herein. In some implementations, the NE may execute a set of instructions to control the function elements of the NE to perform the described functions.

At 1502, the method may include configuring an SS block to include a PSS at a first symbol and an SSS at a second symbol adjacent to the first symbol. The operations of 1502 may be performed in accordance with examples as described herein. In some implementations, aspects of the operations of 1502 may be performed by an NE as described with reference to FIG. 15.

At 1504, the method may include transmitting an SS block burst comprising multiple configured SS blocks, wherein each SS block is transmitted using a different transmission beam of multiple transmission beams. The operations of 1504 may be performed in accordance with examples as described herein. In some implementations, aspects of the operations of 1504 may be performed by an NE as described with reference to FIG. 14.

It should be noted that the method described herein describes a possible implementation, and that the operations and the steps may be rearranged or otherwise modified and that other implementations are possible.

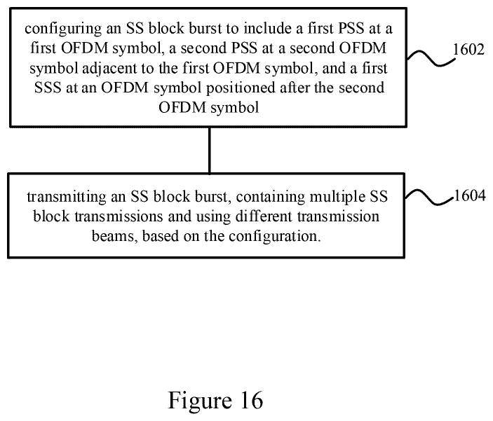

FIG. 16 illustrates a flowchart of a method in accordance with aspects of the present disclosure. The operations of the method may be implemented by an NE as described herein. In some implementations, the NE may execute a set of instructions to control the function elements of the NE to perform the described functions.

At 1602, the method may include configuring an SS block burst to include a first PSS at a first OFDM symbol, a second PSS at a second OFDM symbol adjacent to the first OFDM symbol, and a first SSS at an OFDM symbol positioned after the second OFDM symbol. The operations of 1602 may be performed in accordance with examples as described herein. In some implementations, aspects of the operations of 1602 may be performed by an NE as described with reference to FIG. 14.

At 1604, the method may include transmitting the SS block burst based on the configuration. The operations of 1604 may be performed in accordance with examples as described herein. In some implementations, aspects of the operations of 1604 may be performed by an NE as described with reference to FIG. 14.

It should be noted that the method described herein describes a possible implementation, and that the operations and the steps may be rearranged or otherwise modified and that other implementations are possible.

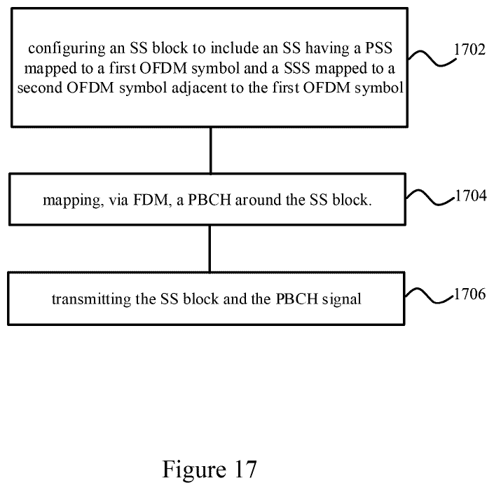

FIG. 17 illustrates a flowchart of a method in accordance with aspects of the present disclosure. The operations of the method may be implemented by an NE as described herein. In some implementations, the NE may execute a set of instructions to control the function elements of the NE to perform the described functions.

At 1702, the method may include configuring an SS block to include an SS having a PSS mapped to a first OFDM symbol and a SSS mapped to a second OFDM symbol adjacent to the first OFDM symbol. The operations of 1702 may be performed in accordance with examples as described herein. In some implementations, aspects of the operations of 1702 may be performed by an NE as described with reference to FIG. 14.

At 1704, the method may include mapping, via FDM, a PBCH around the SS block. The operations of 1704 may be performed in accordance with examples as described herein. In some implementations, aspects of the operations of 1704 may be performed by an NE as described with reference to FIG. 14.

At 1706, the method may include transmitting the SS block. The operations of 1706 may be performed in accordance with examples as described herein. In some implementations, aspects of the operations of 1706 may be performed by an NE as described with reference to FIG. 14.

It should be noted that the method described herein describes a possible implementation, and that the operations and the steps may be rearranged or otherwise modified and that other implementations are possible.

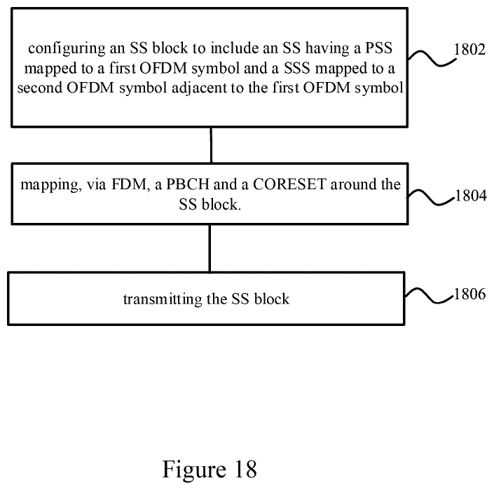

FIG. 18 illustrates a flowchart of a method in accordance with aspects of the present disclosure. The operations of the method may be implemented by an NE as described herein. In some implementations, the NE may execute a set of instructions to control the function elements of the NE to perform the described functions.

At 1802, the method may include configuring an SS block to include an SS having a PSS mapped to a first OFDM symbol and an SSS mapped to a second OFDM symbol adjacent to the first OFDM symbol. The operations of 1802 may be performed in accordance with examples as described herein. In some implementations, aspects of the operations of 1802 may be performed by an NE as described with reference to FIG. 14.

At 1804, the method may include mapping, via FDM, a physical layer broadcast channel PBCH and a CORESET around the SS block. The operations of 1804 may be performed in accordance with examples as described herein. In some implementations, aspects of the operations of 1804 may be performed by an NE as described with reference to FIG. 14.

At 1806, the method may include transmitting the SS block. The operations of 1806 may be performed in accordance with examples as described herein. In some implementations, aspects of the operations of 1806 may be performed by an NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
configure a synchronization signal block (SS block) to include a primary synchronization signal (PSS) at a first symbol and a secondary synchronization signal (SSS) at a second symbol adjacent to the first symbol; and
transmit an SS block burst comprising multiple configured SS blocks, wherein each SS block is transmitted using a different transmission beam of multiple transmission beams.

2. The network entity of claim 1, wherein the at least one processor is further configured to cause the network entity to:
transmit a physical layer broadcast channel (PBCH) burst with a time domain offset from the transmission of the SS block burst.

3. The network entity of claim 2, wherein the PBCH burst contains multiple PBCH block transmissions using different transmission beams of the multiple transmission beams based on the configuration, and
wherein the PBCH burst is based on a quasi-colocation (QCL) assumption with respect to a doppler spread, a doppler shift, an average gain, an average delay, a delay spread, or a spatial receiving parameter, between the SS block burst and the PBCH burst.

4. The network entity of claim 2, wherein a periodicity of the PBCH burst is different or an integer multiple of a periodicity of the SS block burst.

5. The network entity of claim 2, wherein the PBCH burst is part of a minimum system information (MSI) burst, and wherein the at least one processor is further configured to cause the network entity to:
transmit a common channel burst, within an active time of the network entity, which comprises the SS block burst, the MSI burst, a paging burst, and a random access channel (RACH) burst.

6. The network entity of claim 2, wherein the at least one processor is further configured to cause the network entity to:
mapping, via time division multiplexing (TDM) a control resource set (CORESET) to the SS block burst; and
map, via the TDM, an enhanced PBCH (ePBCH) to the PBCH burst.

7. The network entity of claim 6, wherein the at least one processor is further configured to cause the network entity to:
transmit a minimum system information (MSI) burst that comprises the CORESET and the ePBCH.

8. The network entity of claim 1, wherein each SS block of the SS block burst contains the PSS in an orthogonal frequency division multiplexing (OFDM) symbol and the SSS in a consecutive OFDM symbol.

9. The network entity of claim 1, wherein the at least one processor is further configured to cause the network entity to configure the SS block burst to include 7 PSS/SSS occasions in a slot without a gap that contains 14 orthogonal frequency division multiplexing (OFDM) symbols.

10. A method performed by a network entity, the method comprising:
configuring a synchronization signal block (SS block) to include a primary synchronization signal (PSS) at a first symbol and a secondary synchronization signal (SSS) at a second symbol adjacent to the first symbol; and
transmitting an SS block burst comprising multiple configured SS blocks, wherein each SS block is transmitted using a different transmission beam of multiple transmission beams.

11. The method of claim 10, further comprising:
transmitting a physical layer broadcast channel (PBCH) burst with a time domain offset after the transmission of the SS block burst.

12. The method of claim 11, wherein a periodicity of the PBCH burst is different or an integer multiple of a periodicity of the SS block burst.

13. The method of claim 11, wherein the PBCH burst is part of a minimum system information (MSI) burst, further comprising:
transmitting a common channel burst, within an active time of the network entity, which comprises the SS block burst, the MSI burst, a paging burst, and a random access channel (RACH) burst.

14. A network entity for wireless communication, comprising:
at least one memory; and
at least one processor coupled with the at least one memory and configured to cause the network entity to:
configure a synchronization signal block (SS block) burst to include:
a first primary synchronization signal (PSS) at a first orthogonal frequency division multiplexing (OFDM) symbol,
a second PSS at a second OFDM symbol adjacent to the first OFDM symbol, and
a first secondary synchronization signal (SSS) at an OFDM symbol positioned after the second OFDM symbol; and
transmit the SS block burst based on the configuration.

15. The network entity of claim 14, wherein the at least one processor is further configured to cause the network entity to configure the SS block burst to include:
a first physical layer broadcast channel (PBCH) signal at an OFDM symbol that is between the second OFDM symbol and the OFDM symbol mapped to the first SSS; and
a second PBCH signal at an OFDM symbol that is positioned after the OFDM symbol mapped to the first SSS.

16. The network entity of claim 15, wherein the at least one processor is further configured to cause the network entity to configure the SS block burst to include:
a second SSS at an OFDM symbol positioned adjacent to the OFDM symbol mapped to the first SSS.

17. The network entity of claim 14, wherein the OFDM symbol mapped to first SSS is adjacent to the second OFDM symbol, and wherein at least one processor is further configured to cause the network entity to configure the SS block burst to include:
a second SSS at an OFDM symbol adjacent to the OFDM symbol mapped to first SSS.

18. The network entity of claim 14, wherein the at least one processor is configured to cause the network entity to transmit the SS block burst via beam sweeping within a geographical location associated with the network entity.

19. A method performed by a network entity, the method comprising:
configuring a synchronization signal block (SS block) burst to include:
a first primary synchronization signal (PSS) at a first orthogonal frequency division multiplexing (OFDM) symbol,
a second PSS at a second OFDM symbol adjacent to the first OFDM symbol, and
a first secondary synchronization signal (SSS) at an OFDM symbol positioned after the second OFDM symbol; and
transmitting the SS block burst based on the configuration.

20. The method of claim 19, wherein the SS block burst further comprises:
a first physical layer broadcast channel (PBCH) signal at an OFDM symbol that is between the second OFDM symbol and the OFDM symbol mapped to the first SSS; and
a second PBCH signal at an OFDM symbol that is positioned after the OFDM symbol mapped to the first SSS.
